(19) United States
(12) Patent Application Publication
(10) Pub. No.: US 2026/0187490 A1
(43) Pub. Date: Jul. 2, 2026

(54) ADAPTIVE LEARNING PLATFORM

(71) Applicant: International Business Machines Corporation, Armonk, NY (US)

(72) Inventors: Jun Qian Zhou, SHANGHAI (CN); Meng Chai, SHANGHAI (CN); Ke Wen Lin, SHANGHAI (CN); Dan Zhang, SHANGHAI (CN); Yuan Jie Song, SHANGHAI (CN)

(73) Assignee: International Business Machines Corporation, Armonk, NY (US)

(21) Appl. No.: 19/007,887

(22) Filed: Jan. 2, 2025

(51) Int. Cl. G06N 5/022

(52) U.S. Cl. CPC G06N 5/022

(57) ABSTRACT

An embodiment includes establishing, by a system, a knowledge base comprising a set of nodes, each node in the set of nodes representing an entity extracted from a dataset received by the system, where at least two nodes have a hierarchical relationship. The embodiment includes creating a node in the knowledge base according to a familiarity metric, the familiarity metric based on traversing the set of nodes of the knowledge base. The embodiment includes generating a prediction metric for a user of the system for each node of the knowledge base where the prediction metric is generated based in part on an ancestor node where the ancestor node preexists in the knowledge base. The embodiment also includes adjusting the prediction metric based on feedback of the user where the prediction metric predicts understanding of the entity of the dataset by the user.

### BACKGROUND

The present invention relates generally to data storage. More particularly, the present invention relates to a method, system, and computer program for An Adaptive Learning Platform.

Artificial intelligence (AI) technology has evolved significantly over the past few years. Modern AI systems are achieving human level performance on cognitive tasks like converting speech to text, recognizing objects and images, or translating between different languages. This evolution holds promise for new and improved applications in many industries.

A knowledge base is a collection of interlinked descriptions of entities (real-world objects, events, situations or concepts) that enables storage, analysis and reuse of this knowledge in a machine-interpretable way. As a result, it empowers search engines and other content retrieval applications to interpret text and match it to advanced queries. A knowledge base in a datastore may receive data from unstructured data sources, divides the data into blocks of text, converts from text into embeddings, and stores them in a vector database. Knowledge bases offer on-demand support by addressing common queries and providing guidance on successful product or service usage. A knowledge base to solve issues independently, while support agents can rely on it to promptly surface solutions.

### SUMMARY

The illustrative embodiments provide for An Adaptive Learning Platform. An embodiment includes establishing, by a system, a knowledge base comprising a set of nodes, each node in the set of nodes representing an entity extracted from a dataset received by the system, wherein at least two nodes have a hierarchical relationship. The embodiment includes creating a node in the knowledge base according to a familiarity metric, the familiarity metric based on traversing the set of nodes of the knowledge base. The embodiment includes generating a prediction metric for a user of the system for each node of the knowledge base wherein the prediction metric is generated based in part on an ancestor node wherein the ancestor node preexists in the knowledge base. The embodiment also includes adjusting the prediction metric based on feedback of the user wherein the prediction metric predicts understanding of the entity of the dataset by the user.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a flowchart of an adaptive learning platform in an environment in accordance with an illustrative embodiment;

FIG. 3 depicts a diagram of the decision process whether to create a knowledge base node in accordance with an illustrative embodiment;

FIG. 4 depicts a diagram of knowledge base node creation in accordance with an illustrative embodiment;

FIG. 5 depicts a block diagram of adjusting factor usage in accordance with an illustrative embodiment; and

FIG. 6 depicts a system diagram in accordance with an illustrative embodiment.

### DETAILED DESCRIPTION

The depth and expanse of understanding a technical field is so vast that a subject area may comprise hundreds of topics and subtopics. People with different technical background knowledge can have different needs when learning the same technical material, for instance, those with profound knowledge background in the field may need just a summary; and those with weak knowledge background in the field may need more such as introductory and basic concepts or principles can help with one's understanding. Keeping track of what technical materials a user is familiar with or likely to be familiar with requires a platform that can adapt to the user's capacity and speed to learn the training materials as well as making informed predictions about a user's familiarity of the topics. Additionally, the platform will need to handle requests about the user's knowledge of the materials in an efficient and timely manner in an operational setting.

A knowledge base may receive training material from unstructured data sources, divide the data into blocks of text, converts from text into embeddings, and stores them in a vector database. However, a knowledge base like other databases suffers from performance and resource inefficiencies as the size of the data increases and the relationships between the data points become more complex.

Currently there is no way to provide simultaneous storing, querying and user feedback of learning materials that a user understands or familiar with in an efficient operational setting. These current limitations make it impossible to provide efficient, cost-effective and self-aware services, pertaining specifically to data store, to end users. As a result, current efforts in this regard are inefficient and ineffective due to the current inability to determine where significant degradations are occurring in the power network.

The present disclosure provides a process (as well as a system, method, machine-readable medium, etc.) for An Adaptive Learning Platform. For the sake of clarity of the description, and without implying any limitation thereto, the term “adaptive” as used herein may refer to a dynamic, responsive, automatic and/or transformative, in combination or similar actions of a platform to constructs a knowledge base using common hierarchical levels of each scientific area and introduces a unique ability to dynamically supplement and refill the knowledge base as users absorb additional information. This involves maintaining knowledge profiles, utilizing adjusting factors based on user interactions and feedback, and predicting users' comprehension of new information. Additionally, the knowledge base may be dynamically updated as needed, resulting in reduced storage requirements and enhanced efficiency for knowledge-level queries for improved operational performance.

Embodiments disclosed herein describe the system as comprising a datastore such as a graph database, a graphical user interface component, a chunking component, a knowledge summarization component, a prediction component, a feedback component, and a recommendation component. It should be understood that the functions of the various components may be combined to result in fewer components. For example, in some embodiments, the datastore, the knowledge summarization component, and the prediction component may be combined into one component. Embodiments disclosed herein describe a machine learning component as using a machine learning algorithm to perform machine learning tasks including but not limited to predicting, clustering, and regression.

In embodiments illustrated herein, the system detects a dataset from data sources of the network where the dataset may comprise of data collected from monitoring network component in a variety of data formats including Extensible Markup Language (XML), binary stream, hexadecimal, Hypertext Markup Language (HTML) and other structured and unstructured data formats.

Illustrative embodiments disclosed herein describe establishing, by a system, a knowledge base comprising a set of nodes, each node in a set of nodes representing an entity extracted from a dataset received by the system, wherein at least two nodes have a hierarchical relationship. A knowledge base as used herein may comprise a central hub for storing and retrieving essential information, documents, and resources. A knowledge base may be a graph database which is a systematic collection of data that emphasizes the relationships between the different data nodes. In some other embodiments, a knowledge base may be a relational database.

The nodes of the knowledge base as depicted herein may represent an entity or discrete object. Nodes can be connected by relationships, hold data in properties, and are classified by labels. The hierarchical relationship as depicted in some embodiments may mean that the nodes have a parent-child relationship. Each parent node may have multiple child nodes.

Illustrative embodiments disclosed herein describe a dataset which may comprise an instructional material including text, audio, visual media. Text media includes printed and displayed text such as textbooks, pamphlets, handouts, study guides, manuals, blackboard and whiteboard. Audio media refers to human voice and sounds. Visual media may include charts, real objects, photographs, transparencies, slides, tapes, films, filmstrips, television, video, and multimedia.

An entity as described in embodiments herein may comprise a segment, a chunk, a part, a token or similar. In some embodiments, an entity may further comprise a keyword summary of the chunk.

Illustrative embodiments disclosed herein describe creating a node in the knowledge base according to a familiarity metric, the familiarity metric based on traversing the set of nodes of the knowledge base. In embodiments, a familiarity metric comprises a metric generated by system, including but not limited to a count, a percentage, a combination or similar indicating how frequently a user has encountered a node.

Illustrative embodiments disclosed herein also describe generating a prediction metric for a user of the system for each node of the knowledge base wherein the prediction metric is generated based in part on an ancestor node wherein the ancestor node preexists in the knowledge base. The term “ancestor node” as used herein may mean a node in the knowledge base that is related to at least another node such as familial, parent-child, or similar.

Illustrative embodiments disclosed herein describe a prediction metric which may comprise of a percentage, a number, a scale, a dataset or their combination or similar. A prediction metric may be generated by using known machine learning techniques such as K-Nearest Neighbors (KNN), Gradient Boosting, and regression applied to historical data.

Illustrative embodiments disclosed herein describe adjusting the prediction metric based on feedback of the user wherein the prediction metric predicts understanding of the entity of the dataset by the user. The term “adjusting” as used in embodiments herein may mean to change a value of the prediction metric to a different value. Embodiments disclosed herein describe feedback which may mean a response or a type of user interaction including but not limited to a questions and answer, a prompt, a form, a survey or a combination or similar received over a network, via a graphical user interface, in combination or similar. In some embodiments, the term “adjusting” may also mean changing the format from one type to another such as binary to hexadecimal or HTML to XML.

Illustrative embodiments disclosed herein describe the term “understanding” which may refer to a measure of a user's familiarity of the entity represented by a node of the knowledge base. In embodiments, this measure is determined according to the familiarity metric, prediction metric, in combination or similar.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

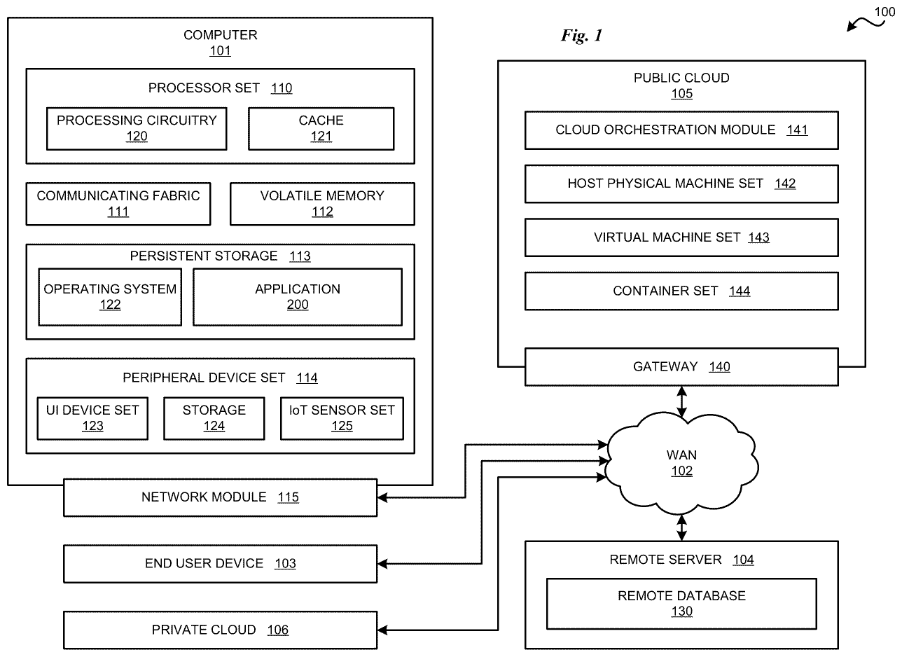

With reference to FIG. 1, this figure depicts a block diagram of a computing environment 100. Data center environment 100 contains an example of an environment for the execution of at least some of the computer code involved in performing the inventive methods, such as an Application module 200 that provides An Adaptive Learning Platform. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made. Available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of Application Programming Interfaces (API). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

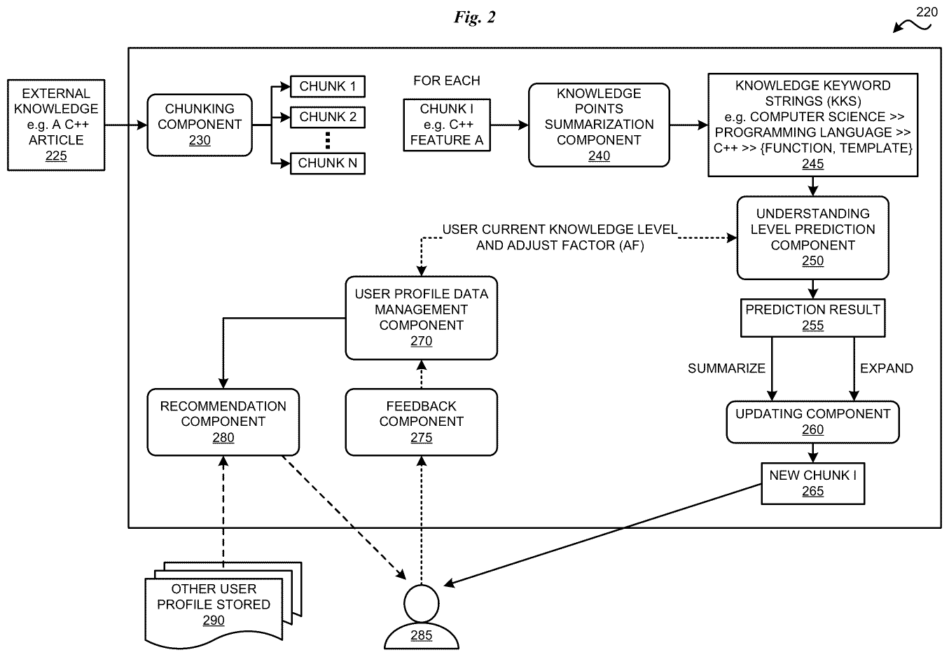

FIG. 2 depicts a flowchart of an adaptive learning platform in an environment in accordance with an illustrative embodiment. In a particular embodiment, the diagram 220 shows aspects of the application 200 of FIG. 1.

In the illustrated embodiment, a dataset 225 such as an article about a topic is received by the system. For example, the dataset may be an article about the C++ programming language. In embodiments, the data request may comprise of data collected from monitoring network component such as GitHub issue, and ticket system such as JIRA and ServiceNow SNOW in a variety of data formats including Extensible Markup Language (XML), binary stream, hexadecimal, Hypertext Markup Language (HTML) and other structured and unstructured data formats.

At step 230, the chunking component generates chunks from the dataset. In embodiments, the chunking component parses the dataset and clusters it into several continuous semantically cohesive chunks. For example, a typical implementation would be semantic adjacent clustering based method, which can be enhanced by AI capabilities to obtain a better chunking result. The resulting chunks, which hold semantically cohesive information, are then passed to the knowledge points summarization component for processing. In embodiments, chunking is the process of breaking down large pieces of text into smaller segments. Known methods of chunking include fixed-size chunking, sentence splitting, Markdown and LaTeX, and semantic chunking.

At step 240, the knowledge points summarization component generates a hierarchical knowledge points keywords string for each chunk. For example, there is a chunk describing C++ language template function, and its string can be “computer_science>>programming_language>>c++>> {function, template}”. Here, “A>>B” signifies that knowledge B is subordinate to A. When B is in the form of “{x, y, z}”, it means that all x, y, z are subordinate to A and they are parallel. Such hierarchical knowledge keywords may also be generated by a well-trained machine learning model. For example, natural language processing techniques such as extraction-based summarization and abstraction-based summarization may be used.

At step 250, the understanding level prediction component (ULP) obtains a knowledge keyword string from the knowledge points summarization component and queries the user profile data management component (UPDM) with it for user understanding level on this knowledge point and the adjusting factor, passes them to the machine learning component to predict how likely the user understands the given keyword string.

When ULP queries with a keyword string, UPDM will perform:

| | |
|---|---|
| 1 | Starting from the initial node (which always |
| | represents the root node) |
| 2 | Push the current node if we want to consider |
| | N closest ancestor nodes, and then check all |
| | its children with keyword |
| 3 | If some node matches, advanced to it, repeat |
| | the searching at 2 |
| 4 | If none of the children matches, the current |
| | node is selected, and the process is |
| | terminated. |

When UPDM selects one node, UPDM will get the customized parameters on this node including count, Adjusting Factor (AF) and its N closest ancestor nodes if configured to consider N closet ancestors.

For example, if configured to consider N closet ancestors, a typical prompt is: “If a user comprehends K1 well, knows K2 . . . . Kn, when he reads one paragraph about knowledge K given, what is the probability of mastering this? Please answer a probability from 0 to 100”. In this scenario, the ULP leverages the emerging and evolving machine learning solutions such as large language model (LLM) to generate the prediction metric result at step 255, defining an initial prediction threshold, which can be customized such as 50. Additionally, the system considers individual different characteristics, resulting in an adjusted prediction threshold of (50+Adjusting Factor). It means that if the prediction metric result exceeds the actual prediction threshold, the system considers that the user understands the given chunk well and can summarize the chunk. Otherwise, the system extends the chunk to provide the user with additional contexts.

At step 260, the updating component (UC) updates the given chunk at step 265 based on the prediction result, either by summarizing or expanding it. This process can be assisted by machine learning, for example leveraging the known LLM, which performs summarization and expansion tasks. Once the updating for all chunks finishes, new information will be shown to the user via a graphical user interface (GUI).

At step 270, UPDM builds a knowledge repository for the user's own knowledge points, employing a tree-like data structure initially empty. As users increasingly adopt the learning assistant while reading technical articles, more and more hierarchical knowledge keywords are generated and processed, subsequently updating the knowledge repository. For each given keyword in a hierarchical knowledge keyword string, the system doesn't immediately create a node for it in terms of hierarchical relationships. Instead, the system analyzes the related hierarchical branch and only creates nodes as needed.

In another example, a keyword string has various hierarchical ancestors, and if no node exists, the system records the separate potential children information in the closest common (joint) ancestor. When there is a need to separate it, the system can then create a special node with more than one parent or generate distinct separated nodes based on heuristics that determine the correlation.

In embodiments, considering the user's individual learning characteristics, an Adjusting Factor (AF) and its associated Delta (D) are proposed for each node. These values serve for prediction adjustment. Both AF and D have initial values of zero. Subsequent updates are likely after the user provides feedback on prediction results. If D>0, it indicates that the last prediction threshold was too low and there is a need of an increase, hence a positive number; otherwise, if D<0, it implies a need to decrease the prediction threshold, resulting in a negative number.

In some embodiments, at step 275, the feedback component receives feedback from the user 285 concerning the quality of the prediction results. The feedback component analyzes the inputs and updates specific user-customized profile data such as the Adjusting Factor, etc. In embodiments, feedback may comprise a response or a type of user interaction including but not limited to a questions and answer, a prompt, a form, a survey or a combination or similar received over a network, via a graphical user interface, in combination or similar.

At step 280, the recommendation component suggests additional knowledge points that the current user might be interested in further. In an embodiment, each knowledge area (top node level) is treated as a vector, with all keywords under that node serving as its dimensions. Each user, for example from stored user profiles 290, has their unique vector for every area. The component then calculates and uses the cosine similarity between each pair of user vectors to determine the similarity and provide personalized recommendations.

In embodiments, the ULP may implement a machine learning algorithm such as gradient boosting which is an ensemble machine learning technique that combines a collection of weak models into a single, more accurate and efficient predictive model. These weak models are typically decision trees, which is why the algorithms are commonly referred to as gradient boosted decision trees (GBDTs). Gradient boosting algorithms work iteratively by adding new models sequentially, with each new addition aiming to resolve the errors made by the previous ones. The final prediction of the aggregate represents the sum of the individual predictions of all the models. Gradient boosting combines the gradient descent algorithm and boosting method, with a nod to each component included in its name.

In embodiments, the system may comprise machine learning models. In embodiments, machine learning models may comprise of a supervised learning model where the labeled data sets comprise attributes of historical data requests. As input data is fed into the model, it adjusts its weights until the model has been fitted appropriately. In an embodiment, the input data comprises training text, documents and images. For example, the documents may be historical attribute metrics of historical responses to data requests with associated confidence ratings. Supervised learning uses a training set to teach models to yield the desired output. This training dataset includes inputs and correct outputs, which allow the model to learn over time.

In some embodiments, the machine learning models comprise of an unsupervised learning model that is given raw unlabeled historical data requests. In embodiments, the model infers similarities and differences of the response attributes of the historical data requests based on known methods such as clustering, association and dimensional reduction. It should be noted that in some embodiments, the machine learnings models may comprise of supervised and unsupervised learning models in combination.

In an embodiment, a feature vector represents an entity of a dataset in a vector format where each element of the vector comprises a feature such as a particular attribute's occurrences in the data request. In another embodiment, a feature vector comprises properties of the entities representing the patterns in the entities. For example, the feature vectors may comprise response attributes of a plurality of historical entities. The system performs matrix operations on a large amount of the data represented in the feature vectors to determine patterns in the data.

In an embodiment, the machine learning model implements linear regression is used to identify the relationship between a dependent variable and one or more independent variables and is typically leveraged to make predictions about future outcomes. When there is only one independent variable and one dependent variable, it is known as simple linear regression. As the number of independent variables increases, it is referred to as multiple linear regression. For each type of linear regression, it seeks to plot a line of best fit, which is calculated through the method of least squares. However, unlike other regression models, this line is straight when plotted on a graph.

In another embodiment, the machine learning model implements a Random forest model is a commonly-used machine learning algorithm, that combines the output of multiple decision trees to reach a single result. Random forests are made up of many decision trees, each of which is trained using a random subset of the training data. For example, a decision tree may be trained on a data request specific to a particular industry or organization. Random forest is used for both classification and regression purposes. The “forest” references a collection of uncorrelated decision trees, which are then merged together to reduce variance and create more accurate data predictions.

In some embodiments, the machine learning model may implement a deep learning model where the input layer of the deep learning model processes and passes the data request and response attributes to layers further in the neural network. These hidden layers process information at different levels, adapting their behavior as they receive new information.

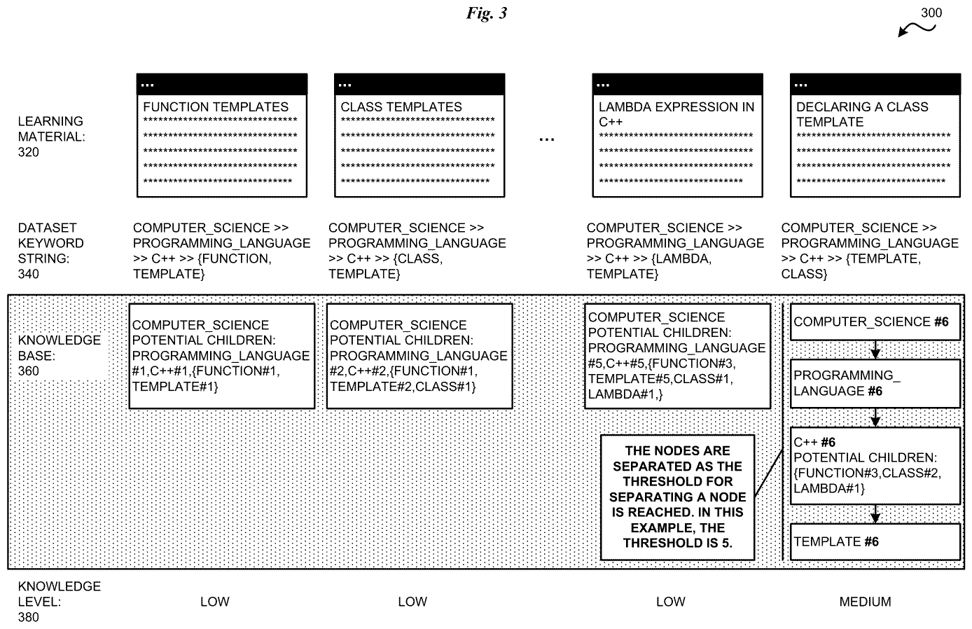

FIG. 3 depicts a diagram of the decision process whether to create a knowledge base node in accordance with an illustrative embodiment. In a particular embodiment, the components of the diagram 300 shows aspects of the application 200 of FIG. 1.

In the illustrated embodiment, the system receives learning material dataset 320 for example, learning material for C++ programming language. The keyword string is extracted 340 and nodes are created in the knowledge base 360. Initially, when the knowledge level 380 is low, for example if the corresponding node does not exist for the first keyword that typically is a top-level knowledge area, the system will create the node in the knowledge base. In some embodiments, the knowledge level 380 may comprise user feedback, a familiarity metric, a prediction metric, a combination or similar. The system also increments a familiarity metric for example, a count, indicating how frequently this user has encountered this knowledge point, offering a measure of the user's familiarity with the knowledge. For each subsequent keyword, the system firstly checks for the existence of a corresponding node by following the hierarchy. If found, the system updates the counts in the existing node. If not found, the system examines the “potential children” list of its closest ancestor node. If the familiarity metric exceeds a specified count threshold, indicating a need for a new node, the system creates one and relocates all subordinate “potential children” from the closest ancestor node to the newly created node. If the threshold is not met, the system updates the responding count in the “potential children” list.

In some embodiments, the system determines a distance between an ancestor node and the entity to decide if or when to create a node in the knowledge base. For example, the distance may be a match, for instance an exact match or a match between a range such as 51% to 100%, of the entity determined by traversing the hierarchy of the knowledge base. In another example, the distance may be determined by machine learning using an algorithm including but not limited to KNN, and regression where the distance comprises known measures: Euclidean distance, Manhattan distance, Minkowski distance, or Hamming distance.

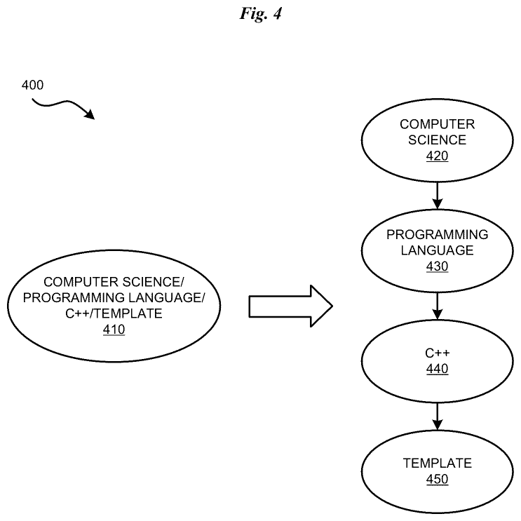

FIG. 4 depicts a diagram of knowledge base node creation in accordance with an illustrative embodiment. In a particular embodiment, the components of the diagram 400 shows aspects of the application 200 of FIG. 1.

In the illustrated embodiment, initially a single node of the knowledge base is created for the entity 410 of a learning material dataset. For example, the entity is the keyword string “Computer Science/Programming Language/C++/Template”. As described above, initially the familiarity metric is initialized with a count of zero. If the familiarity metric exceeds a specified count threshold, indicating a need for a new node, the system creates one and relocates all subordinate “potential children” from the closest ancestor node to the newly created node, if the closest ancestor node can be found. If not found, the keyword string is segmented and a node created for a segment. For example, the keyword string is segmented and new nodes created into a “Computer Science” node 420, a “Programming Language” node 430, a “C++” node 440, and a “Template” node 450. If the count threshold is not met, the system updates the responding count in the “potential children” list.

In embodiments, creating a node of a knowledge base for instance, a graph database, comprises a central processing unit that allocates memory that is typically managed through a combination of on-heap memory for active data access and off-heap memory for storing the graph's topology and indexes, allowing for efficient traversal and query execution. The number of nodes and relationships directly impacts memory usage. Highly connected graphs can consume more memory due to the increased number of relationships. In some embodiments, using counts, familiarity metrics reduces the need for the creation of nodes and relationships.

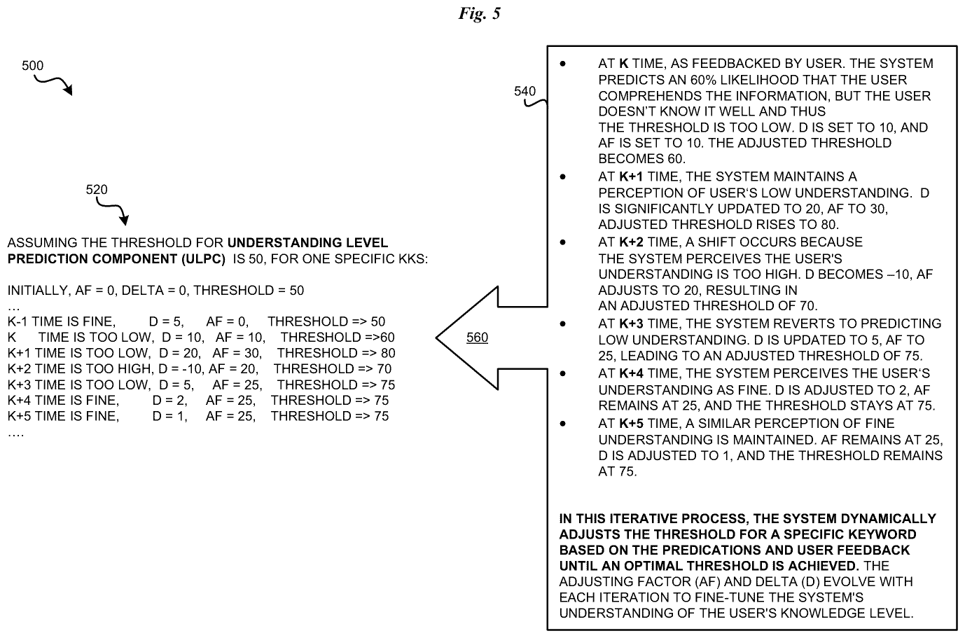

FIG. 5 depicts a block diagram of adjusting factor usage in accordance with an illustrative embodiment. In a particular embodiment, the system components 500 are representative of aspects of the application 200 of FIG. 1.

In the illustrated embodiment, assuming the prediction threshold at the ULP is 50, the adjusting factor, and the delta are zero at 520. In an exemplary iterative process, the system dynamically adjusts the prediction threshold for a specific keyword based on the predication metric and user feedback until an optimal threshold is achieved. The Adjusting factor (AF) and Delta (D) evolve with each iteration to fine-tune the system's understanding of the user's knowledge level. For example, an optimal threshold is achieved when the user feedback and the prediction metric match. In another example, an optimal threshold is achieved when the difference between the user feedback and the prediction metric is within a predefined range.

In an embodiment, the adjusting factor (AF) and delta (D) are determined as follows: Based on the user feedback, if the prediction metric result is:
Good->then AF is unchanged, if D==0, unchanged, otherwise, D=Div2 (D)
Off->consider these cases:

Initial (AF=D=0)->AF unchanged, D=Sign (min_delta, “+”, T_HL)
1. Historical prediction is too low and at this instance is too high, OR historical prediction is too high and at this instance is too low,

$$-> D = Sign ( Div 2 ( D ) , L\_HL , T\_HL )$$

$$-> AF = AF + D$$

2. Historical prediction is too low and at this instance is too low, OR historical prediction is too high and at this instance is too high,

$$-> D = Mul 2 ( D )$$

$$-> AF = AF + D$$

Definitions of max_delta, min_delta and init_delta are;

$$Div 2 ( n ) = ( n / 2 > min\_delta ) ? n / 2 : min\_delta ;$$

$$Mul 2 ( n ) = ( n * 2 < max\_delta ) ? n * 2 : max\_delta ;$$

$$Sign ( n , old\_sign , new\_sign ) = ( old\_sign == new\_sign ) ? n : - n ;$$

T_HL: “−” if at this instance is too high, otherwise “+”;
H_HL: “−” if historical is too high, otherwise “+”;

To retain historical information in the delta, Div2 and Mul2 are introduced to scale the delta, when the prediction metric result becomes worse, adopting Mul2 to enlarge D and give it the best chance to reverse the trend quickly. When the prediction metric result improves according to user feedback, Div2 is adopted to stabilize it promptly.

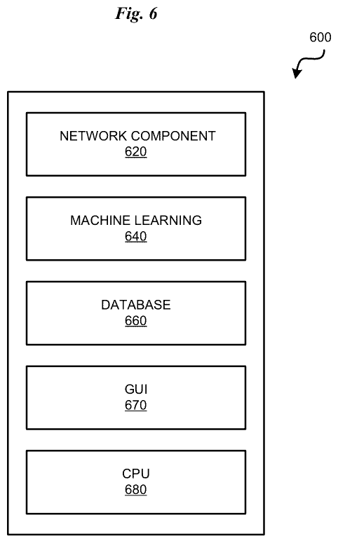

FIG. 6 depicts a system diagram in accordance with an illustrative embodiment. In a particular embodiment, the system components 500 are representative of aspects of the application 200 of FIG. 1.

In the illustrated embodiment, a system comprises a network component 620, a machine learning component 640, a database 660, a graphical user interface (GUI) 670 and a central processing unit (CPU) 680. In an embodiment, the network component 520 comprises a router, network card, switch, a network interface card and related software. The network component may also include data aggregation layer that interacts with another component in the system. The machine learning model 530 may further comprise a neural network with an encoder-decoder architecture accepting input feature vectors to the machine learning model to perform predictions. Graphics Processing Units, (GPU) due to their ability to process tasks simultaneously, may be used for training the neural networks. By conducting numerous calculations at the same time, they can greatly decrease the processing time needed for the large volumes of data that machine learning models use. Tensor Processing Units, on the other hand, created specifically for executing machine learning tasks. Their ability to provide increased efficiency and speed while working with neural networks makes them a transformative technology for training machine learning models.

In embodiments, the database 660 may be a graph database which is a systematic collection of data that emphasizes the relationships between the different data entities or nodes. The graph database may use mathematical graph theory to show data connections. In other embodiments, the database 660 may be a relational database. Unlike relational databases, which store data in rigid table structures, graph databases store data as a network of entities and relationships. In some embodiments, the functionality described herein is distributed among a plurality of systems, which can include combinations of software and/or hardware-based systems, for example Application-Specific Integrated Circuits (ASICs), computer programs, or smart phone applications.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
establishing, by a system, a knowledge base comprising a set of nodes, each node in the set of nodes representing an entity extracted from a dataset received by the system, wherein at least two nodes have a hierarchical relationship;
creating a node in the knowledge base according to a familiarity metric, the familiarity metric based on traversing the set of nodes of the knowledge base;
generating a prediction metric for a user of the system for each node of the knowledge base wherein the prediction metric is generated based in part on an ancestor node wherein the ancestor node preexists in the knowledge base; and
adjusting the prediction metric based on feedback of the user wherein the prediction metric predicts understanding of the entity of the dataset by the user.

2. The computer-implemented method of claim 1, wherein adjusting the prediction metric comprises applying an adjustment factor to a prediction threshold and wherein the prediction threshold is compared with the prediction metric to determine understanding of the entity.

3. The computer-implemented method of claim 2, further comprising iteratively applying a delta to the adjustment factor wherein the delta is determined by comparing the prediction metric with the user feedback.

4. The computer-implemented method of claim 1, wherein creating the node comprises deciding whether to create the node by comparing a distance between the ancestor node and the entity.

5. The computer-implemented method of claim 1, wherein the node is created when the familiarity metric exceeds a user defined count.

6. The computer-implemented method of claim 1, wherein the knowledge base is a graph database wherein each node of the graph database is adaptively created according to a hierarchy of entities of the dataset.

7. The computer-implemented method of claim 1, further comprising recommending to the user according to a cosine similarity of vectors of the set of nodes.

8. A computer program product comprising one or more computer readable storage media, and program instructions collectively stored on the one or more computer readable storage media, the program instructions executable by a processor to cause the processor to perform operations comprising:
establishing, by a system, a knowledge base comprising a set of nodes, each node in the set of nodes representing an entity extracted from a dataset received by the system, wherein at least two nodes have a hierarchical relationship;
creating a node in the knowledge base according to a familiarity metric, the familiarity metric based on traversing the set of nodes of the knowledge base;
generating a prediction metric for a user of the system for each node of the knowledge base wherein the prediction metric is generated based in part on an ancestor node wherein the ancestor node preexists in the knowledge base; and
adjusting the prediction metric based on feedback of the user wherein the prediction metric predicts understanding of the entity of the dataset by the user.

9. The computer program product of claim 8, wherein adjusting the prediction metric comprises applying an adjustment factor to a prediction threshold and wherein the prediction threshold is compared with the prediction metric to determine understanding of the entity.

10. The computer program product of claim 9, further comprising iteratively applying a delta to the adjustment factor wherein the delta is determined by comparing the prediction metric with the user feedback.

11. The computer program product of claim 8, wherein creating the node comprises deciding whether to create the node by comparing a distance between the ancestor node and the entity.

12. The computer program product of claim 8, wherein the node is created when the familiarity metric exceeds a user defined count.

13. The computer program product of claim 8, wherein the knowledge base is a graph database wherein each node of the graph database is adaptively created according to a hierarchy of entities of the dataset.

14. The computer program product of claim 8, further comprising recommending to the user according to a cosine similarity of vectors of the set of nodes.

15. A computer system comprising a processor and one or more computer readable storage media, and program instructions collectively stored on the one or more computer readable storage media, the program instructions executable by the processor to cause the processor to perform operations comprising:
establishing, by a system, a knowledge base comprising a set of nodes, each node in the set of nodes representing an entity extracted from a dataset received by the system, wherein at least two nodes have a hierarchical relationship;
creating a node in the knowledge base according to a familiarity metric, the familiarity metric based on traversing the set of nodes of the knowledge base;
generating a prediction metric for a user of the system for each node of the knowledge base wherein the prediction metric is generated based in part on an ancestor node wherein the ancestor node preexists in the knowledge base; and
adjusting the prediction metric based on feedback of the user wherein the prediction metric predicts understanding of the entity of the dataset by the user.

16. The computer system of claim 15, wherein adjusting the prediction metric comprises applying an adjustment factor to a prediction threshold and wherein the prediction threshold is compared with the prediction metric to determine understanding of the entity.

17. The computer system of claim 16, further comprising iteratively applying a delta to the adjustment factor wherein the delta is determined by comparing the prediction metric with the user feedback.

18. The computer system of claim 15, wherein creating the node comprises deciding whether to create the node by comparing a distance between the ancestor node and the entity.

19. The computer system of claim 15, wherein the node is created when the familiarity metric exceeds a user defined count.

20. The computer system of claim 15, wherein the knowledge base is a graph database wherein each node of the graph database is adaptively created according to a hierarchy of entities of the dataset.
